(19) United States
(12) Patent Application Publication
(10) Pub. No.: US 2018/0323635 A1
(43) Pub. Date: Nov. 8, 2018

(54) ENCLOSURE TO RECHARGE SMART-CHARGING CLOTHING

(71) Applicant: INTEL CORPORATION, SANTA CLARA, CA (US)

(72) Inventors: Tyler FETTERS, Hillsboro, OR (US); Lakshman KRISHNAMURTHY, Portland, OR (US)

(21) Appl. No.: 15/775,377

(22) PCT Filed: Dec. 10, 2015
(86) PCT No.: PCT/US15/64852

§ 371 Date: May 10, 2018

(51) Int. Cl. H02J 7/02; H02J 7/00; H02J 50/90; A47G 25/00

(52) U.S. Cl. CPC H02J 7/025; H02J 7/0042; H02J 50/12; A47G 25/00; H02J 50/90

(57) ABSTRACT

The present disclosure includes a method of recharging a smart-charging clothing. The method comprises inserting a smart-charging clothing into a holder; storing the holder in an enclosure; connecting the smart-charging clothing to a recharging interface; recharging the smart-charging clothing using the recharging interface; removing the holder from the enclosure; and removing the smart-charging clothing from the holder.

### FIELD OF THE DISCLOSURE

The present disclosure relates to an apparatus for and a method of recharging a smart-charging clothing in a powered enclosure.

### BACKGROUND OF THE DISCLOSURE

Wearable devices are designed, fabricated, and assembled with disparate shapes, sizes, and structures by a variety of suppliers. They are often operated with DC power from a battery. However, the battery is often small, compact, and light in weight so as to accommodate constraints of the wearable devices. Thus, the battery needs to be recharged after a period of use.

The recharger for the battery is usually customized for the particular wearable device. As a result, a user has to purchase multiple rechargers. In one instance, the user must carry around the appropriate recharger for use as needed with each wearable device as the battery becomes completely depleted.

In another instance, the user must take the wearable device to where the appropriate recharger is stored and recharge the wearable device on a schedule before the battery becomes depleted. Both instances pose a recurring logistical challenge especially when the recharger is larger and heavier than the wearable device itself.

As the wearable devices become smaller in size and greater in number, the user must invest ever more resources in money and time to keep the wearable devices operating in an optimal condition.

Thus, it would be desirable to disclose an apparatus and method that addresses these enumerated issues in a timely and cost effective manner. In particular, the various embodiments of the claimed disclosure may be usefully applied to recharge various wearable devices as they continue to proliferate in the future.

### BRIEF DESCRIPTION OF THE DRAWINGS

To facilitate understanding, identical reference numerals have been used, wherever possible, to designate identical elements that are common to the figures. The drawings are not to scale and the relative dimensions of various elements in the drawings are depicted schematically and not necessarily to scale.

The techniques of the present disclosure may readily be understood by considering the following detailed description in conjunction with the accompanying drawings, in which:

FIG. 1 is a schematic diagram of an enclosure including one or more modules to recharge smart-charging clothing placed inside.

FIG. 2A is a schematic diagram of one or more smart-charging clothing to be recharged in parallel.

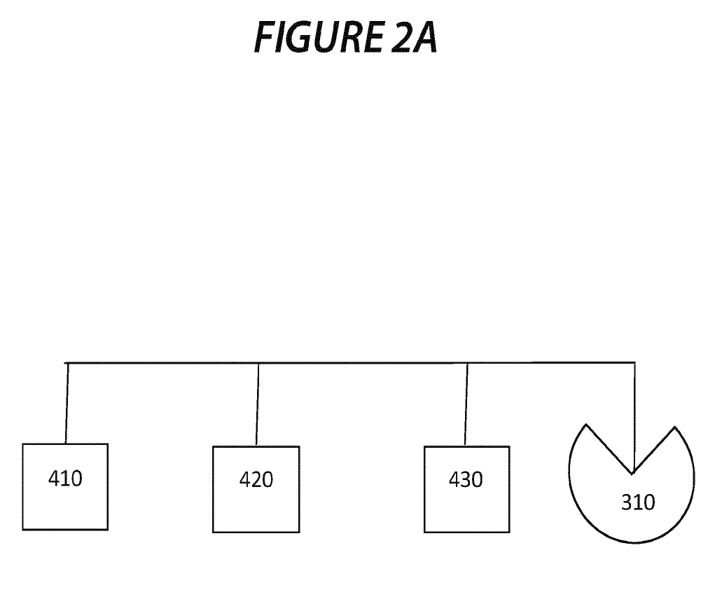

FIG. 2B is a schematic diagram of one or more smart-charging clothing to be recharged in series.

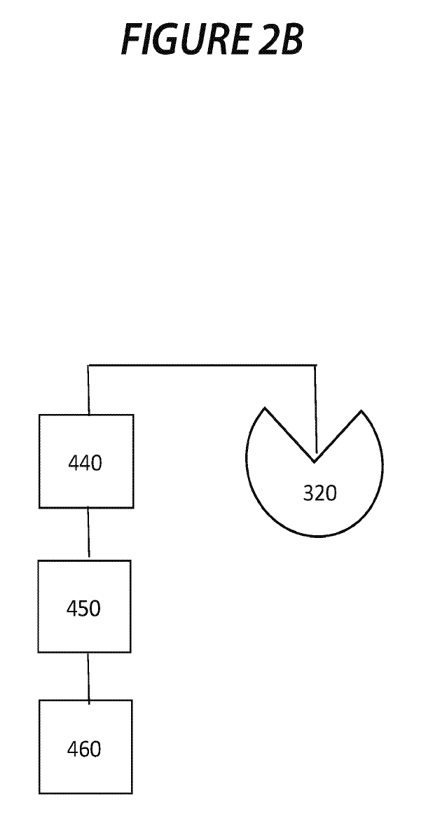

FIG. 3A is a schematic diagram of a smart-charging clothing in physical contact with a recharging interface.

FIG. 3B is a schematic diagram of a smart-charging clothing in wireless contact with a recharging interface.

FIG. 4A is a schematic diagram of a hanger for smart-charging clothing to be recharged with a recharging interface.

FIG. 4B is a schematic diagram of a garment bag for one or more articles of smart-charging clothing to be recharged with a recharging interface.

FIG. 4C are schematic diagram of a rack for smart-charging clothing to be recharged with a recharging interface.

FIG. 5 is a flowchart for recharging smart-charging clothing in an enclosure.

### DETAILED DESCRIPTION

Before the present disclosure is described in detail, it is to be understood that, unless otherwise indicated, this disclosure is not limited to specific procedures or articles, whether described or not.

It is further to be understood that the terminology used herein is for the purpose of describing particular embodiments only and is not intended to limit the scope of the present disclosure.

It must be noted that as used herein and in the claims, the singular forms “a,” and “the” include plural referents unless the context clearly dictates otherwise. Thus, for example, reference to “an enclosure” also includes two or more enclosures, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” generally refers to ±10% of a stated value.

Methods of and apparatuses for recharging smart-charging clothing 500 are disclosed herein. Embodiments of methods of the present disclosure will be described followed by embodiments of apparatuses of the present disclosure.

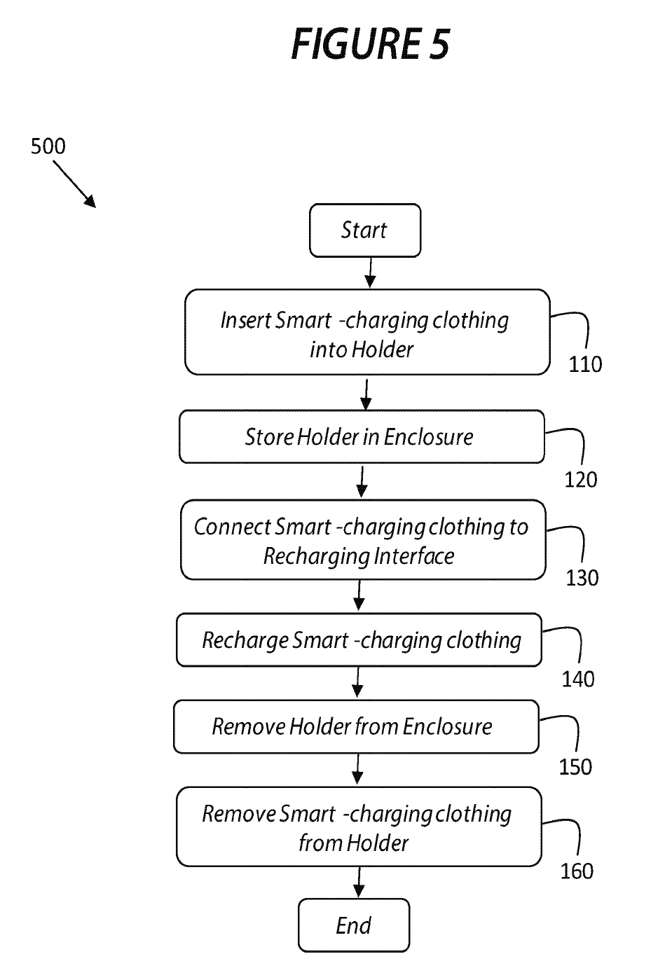

A method of the present disclosure includes a sequence of inserting, storing, connecting, recharging, and removing one or more smart-charging clothing 500 from an enclosure 100 of the claimed disclosure, as shown in FIG. 5.

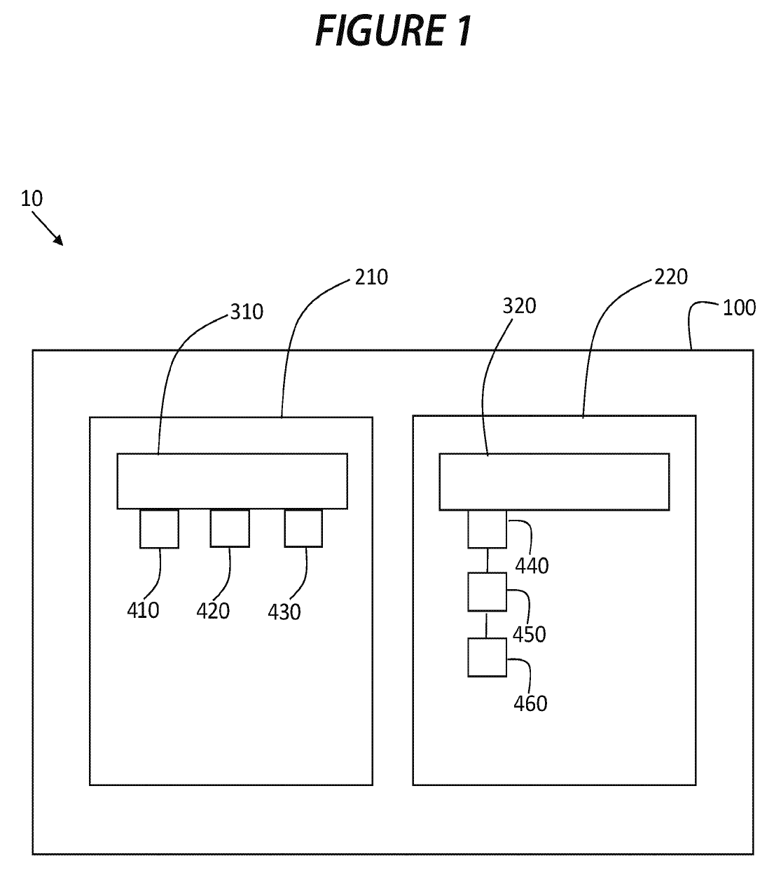

A recharging enclosure 100 may recharge a smart-charging clothing 500, as shown in FIG. 1. The smart-charging clothing 500 may comprise a shirt, a blouse, a pair of shorts, a pair of pants, a skirt, a jacket, a suit, a pair of socks, or a pair of shoes with electronics embedded therein. The enclosure 100 may include one or more modules 210, 220. The modules 210, 220 may be identical, similar, or different.

The smart-charging clothing 500 may include a communication device in some embodiments. The smart-charging clothing 500 may include a time tracking and display device, such as a watch, timer, stop-watch, or alarm. The smart-charging clothing 500 may include a biometric device, such as a health monitor, health alert, or health alarm. The smart-charging clothing 500 may include an information, or data, acquisition and playback device, such as a personal recorder, or personal digital assistant.

First, the smart-charging clothing 500 is inserted into a holder 410, 420, 430, 440, 450, 460, as shown in Block 110 of FIG. 5.

Various holders 410, 420, 430, 440, 450, 460 are shown in FIG. 1. The holders 410, 420, 430, 440, 450, 460 may be customized for the smart-charging clothing 500 to accommodate its features, such as shape, size, or weight.

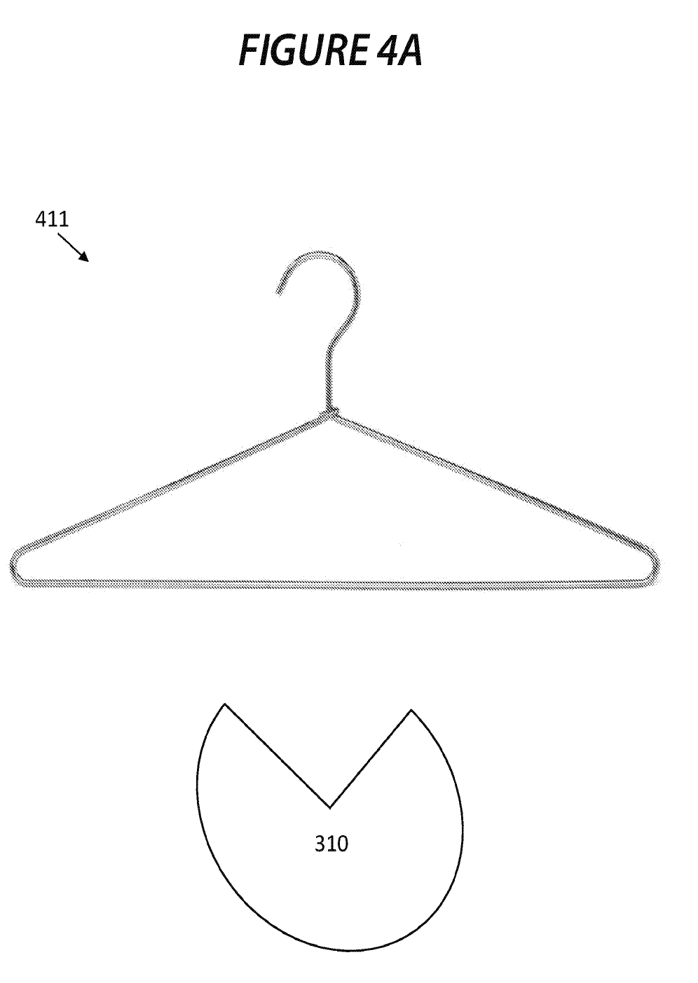

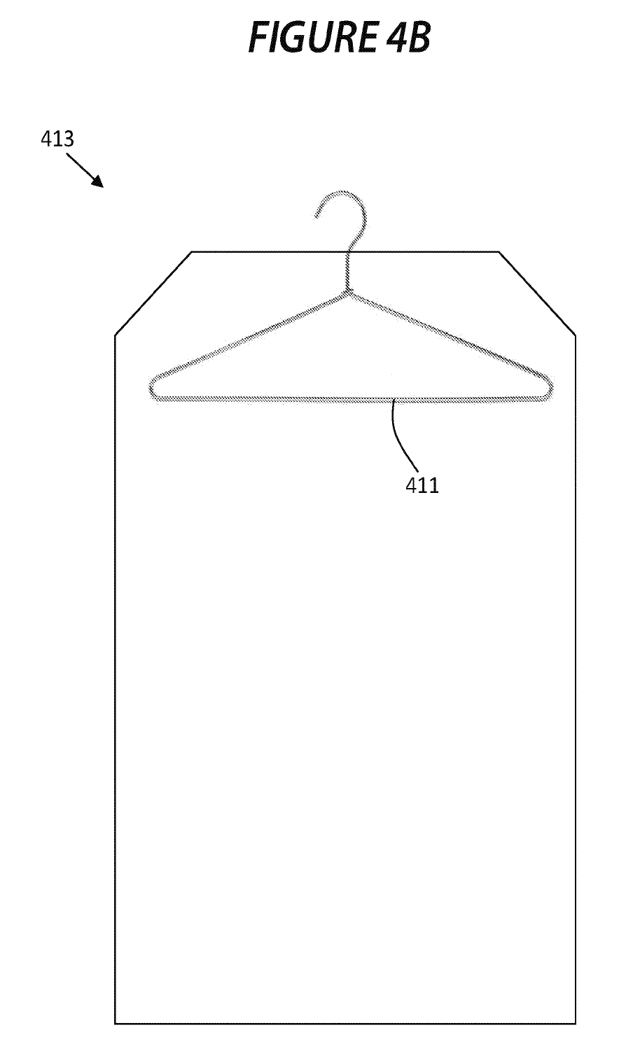

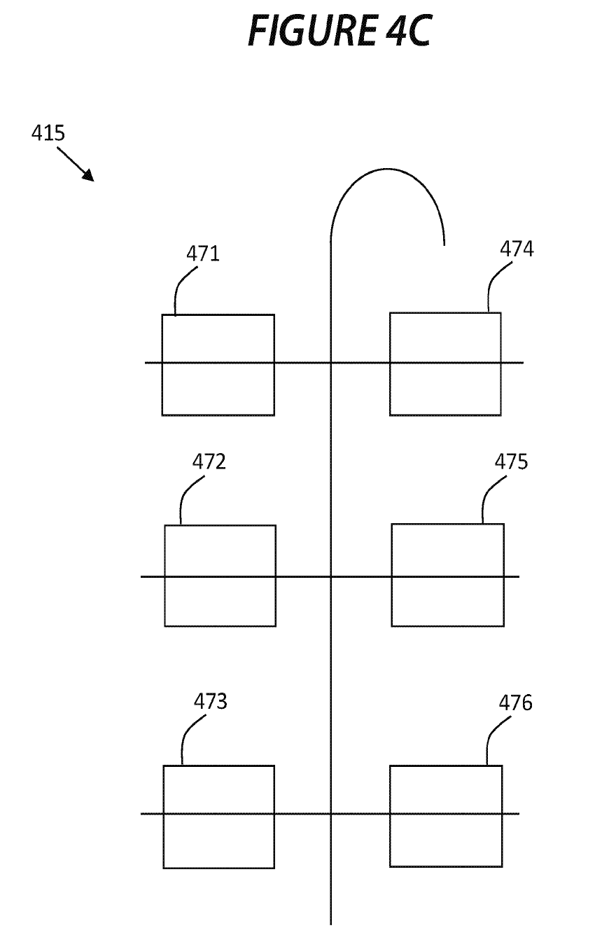

In various embodiments of the present disclosure, the holder 410, 420, 430, 440, 450, 460 may include a hanger 411 as shown in FIG. 4A, a garment bag 413 as shown in FIG. 4B, or a rack 415 of holders 471-476 as shown in FIG. 4C.

Second, the holder 410, 420, 430, 440, 450, 460 is stored in an enclosure 100, as shown in Block 120 of FIG. 5. In an embodiment of the present disclosure as shown in FIG. 1, the enclosure 100 may include a closet, a cupboard, or a box in a form of dwelling, such as a room, an apartment, or a house. In another embodiment of the present disclosure, the enclosure 100 may include a console or a compartment in a form of transportation, such as a motorized vehicle, a car, a truck, a ship, or an aircraft. In still another embodiment of the present disclosure, the enclosure 100 may include a console or a compartment in a form of storage, such as a shed or a trailer.

In various embodiments of the present disclosure, the recharging interface 310, 320 may include a rod as shown in FIG. 1.

Third, the smart-charging clothing 500 is connected to the recharging interface 310, 320, as shown in Block 130 of FIG. 5. The smart-charging clothing 500 may comprise a contact, a paddle, or a clip to connect to the recharging interface 310, 320. The connection may be implemented indirectly (such as through the holder 410, 420, 430, 440, 450, 460) or directly (such as bypassing the holder 410, 420, 430, 440, 450, 460). Adjacent holders may be kept separate from each other by slots (or spacers) between the respective holders.

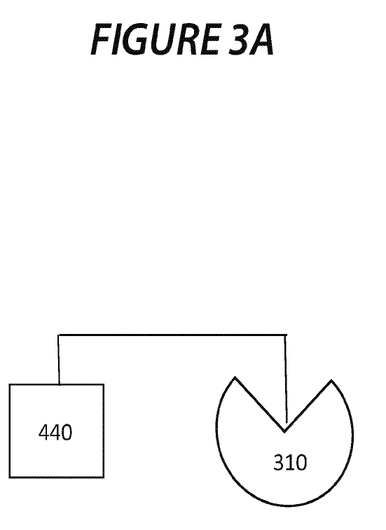

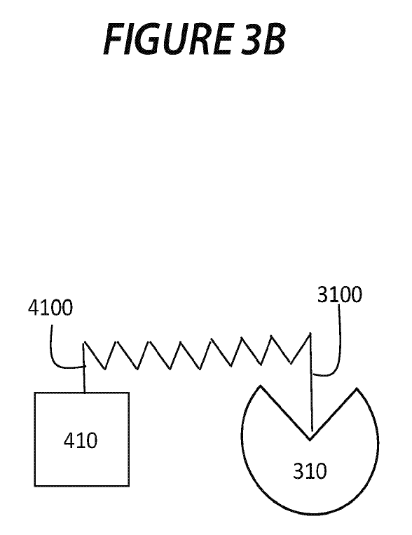

The connecting of smart-charging clothing 500 via holder 410 to the recharging interfaces 310, 320 may be through (direct) physical contact such as shown in FIG. 3A or through (indirect) wireless contact such as shown on FIG. 3B. To prevent electric shock when paddles or contacts in smart-charging clothing 500 are exposed, conductive charging (with physical contact) may include use of safety interlocks, special connectors, and ground fault interrupters (GFI) that quickly disconnect current upon detecting any very small (residual) leakage current.

The paddles or contacts in smart-charging clothing 500 may be protected from oxygen or water in the atmosphere to prevent corrosion. Charging through physical contact may be simpler, cheaper, and faster than through wireless contact. However, wireless contact may be more durable, and more reliable compared to physical contact.

Fourth, the smart-charging clothing 500 are recharged, as shown in Block 140. Smart-charging clothing 500 have different power requirements depending on specific consumer electronic device functionality. Laptop computer functionality requires about 65-90 watts. Tablet computer functionality requires about 25-30 watts. However, other wearable device functionality may only require about 2-10 watts.

Recharging the smart-charging clothing 500 may be accomplished through contact recharging or non-contact recharging. The non-contact recharging may be through inductance, or resonance, or a combination of inductance and resonance.

Inductive charging may result in higher resistive heating and thus lower efficiency and slower recharging. However, transfer losses for inductive charging may be decreased by using an ultra-thin coil. Furthermore, inductive charging may be improved by optimizing power management in the drive electronics. In an embodiment of the present disclosure, high-frequency induction charging may have an efficiency of 90-95%.

In an embodiment of the present disclosure, a secondary (pick up or receiver) induction coil in the holder 410, 420, 430, 440, 450, 460 is aligned and placed in proximity with a primary (charger or sender or transmission) induction coil in the recharging interface 310, 320. A power panel may supply AC current, such as through an inverter, to the primary coil in the recharging interface 310, 320. The two induction coils precisely located (aligned) in proximity may combine to form an electrical transformer. The primary coil may be electrically charged to generate a magnetic field that induces AC current in the secondary coil in the holder 410, 420, 430, 440, 450, 460 to be converted to DC current, such as through a rectifier, to recharge a battery pack in the smart-charging clothing 500.

In an embodiment of the present disclosure, the primary induction coil in the recharging interface 310, 320 may be movable by being mounted onto an actuator, such as an arm fixture, that may pivot, elevate, turn, and rotate. In another embodiment of the present disclosure, the secondary coil in the holder 410, 420, 430, 440, 450, 460 may be fabricated from silver-plated copper or aluminum to reduce weight and decrease resistance due to a skin effect.

In an embodiment of the present disclosure, inductive charging may use a frequency of 120-250 kHz. In an embodiment of the present disclosure, coil-to-coil spacing may be about 5-10 cm.

Inductive charging may be improved by using a higher frequency. In an embodiment of the present disclosure, a frequency of 6.78 MHz may be used. In an embodiment of the present disclosure, a frequency of 13.56 MHz may be used. Inductive recharging at higher frequency may go through obstructions without being impeded. In an embodiment of the present disclosure, high-frequency induction charging may have an efficiency of 70-75%. In an embodiment of the present disclosure, high-frequency induction charging may have an efficiency of 80-85%. In an embodiment of the present disclosure, coil-to-coil spacing may be 30-50 cm.

Resonant inductive coupling may be used to allow a greater intervening space (separation or gap) between the primary coil in the recharging interface 310, 320 and the secondary coil in the holder 410, 420, 430, 440, 450, 460. In an embodiment of the present disclosure, a curved coil and capacitive plates may be used to add resonance to the inductance. To achieve resonant coupling, each coil is capacitively loaded so as to form an LC circuit. In an embodiment of the present disclosure, the spacing between the primary coil in the recharging interface 310, 320 and the secondary coil in the holder 410, 420, 430, 440, 450, 460 may be 1-2 meters. In another embodiment of the present disclosure, the spacing between the primary coil in the recharging interface 310, 320 and the secondary coil in the holder 410, 420, 430, 440, 450, 460 may be 3-5 meters.

Fifth, the holder 410, 420, 430, 440, 450, 460 may be removed from the enclosure 100, as shown in Block 150 of FIG. 5. When the holder 410, 420, 430, 440, 450, 460 is removed from the enclosure 100, the recharging of the smart-charging clothing 500 may be interrupted or stopped. When the holder 410, 420, 430, 440, 450, 460 is removed from the enclosure 100, the recharging of the smart-charging clothing 500 may already be completed or may still not be completed.

In an embodiment of the present disclosure, the enclosure 100 may include a closet, a cupboard, or a box in a form of dwelling, such as a room, an apartment, or a house. In another embodiment of the present disclosure, the enclosure 100 may include a console or a compartment in a form of transportation, such as a motorized vehicle, a car, a truck, a ship, or an aircraft. In still another embodiment of the present disclosure, the enclosure 100 may include a console or a compartment in a form of storage, such as a shed or a trailer.

The enclosure 100 may include one or more modules 210, 220. The modules 210, 220 may be identical, similar, or different.

Sixth, the smart-charging clothing 500 may be removed from the holder, as shown in Block 160 of FIG. 5.

Various holders 410, 420, 430, 440, 450, 460 are shown in FIG. 1. The holders 410, 420, 430, 440, 450, 460 may be customized for the smart-charging clothing 500 to accommodate their features, such as shape, size, or weight.

In various embodiments of the present disclosure, the holders 410, 420, 430, 440, 450, 460 may include a hanger 411 as shown in FIG. 4A, a garment bag 413, as shown in FIG. 4B, or a rack 415, as shown in FIG. 4C.

Next, various embodiments of an apparatus of the present disclosure will be described. A recharging system or apparatus 10 includes an enclosure 100, as shown in FIG. 1. In an embodiment of the present disclosure, the enclosure 100 may include a closet, a cupboard, or a box in a form of dwelling, such as a room, an apartment, or a house. In another embodiment of the present disclosure, the enclosure 100 may include a console or a compartment in a form of transportation, such as a motorized vehicle, a car, a truck, a ship, or an aircraft. In still another embodiment of the present disclosure, the enclosure 100 may include a console or a compartment in a form of storage, such as a shed or a trailer.

In one embodiment, the recharging system 10 is connected to line voltage and may also have a backup power supply including a battery pack.

The recharging system 10 may include a computer, microprocessor, or microcontroller. The computer may exchange information with the smart-charging clothing 500 in a vicinity to determine whether it is compliant. The determination of recharging status and recharging parameters, such as power levels, may be based on ID of the smart-charging clothing 500.

The recharging system 10 may be connected to a secure wired or wireless network, such as a Local Area Network (LAN) or Personal Area Network (PAN) that includes communication protocols such as Ethernet, 4G LTE, WiFi, Bluetooth, and Zigbee.

The recharging system 10 may also be connected to a programmable timer that may be accessed remotely with encryption.

The enclosure 100 may include one or more modules 210, 220. The modules 210, 220 may be the same, similar, or different.

The module 210 may include one or more recharging interfaces 310. The recharging interface 310 may be connected to holders 410, 420, 430. In an embodiment of the present disclosure, the holders 410, 420, 430 may be connected in parallel.

The module 220 may include one or more recharging interfaces 320. The recharging interface 320 may be connected to wearable holders 440, 450, 460. In an embodiment of the present disclosure, the wearable holders 440, 450, 460 may be connected in series.

In still another embodiment of the present disclosure, some smart-charging clothing 500 may be connected in parallel while other smart-charging clothing 500 may be connected in series.

Various holders 410, 420, 430, 440, 450, 460 are shown in FIG. 1. In various embodiments of the present disclosure, the holders may include a hanger 411 as shown in FIG. 4A, a garment bag 413, as shown in FIG. 4B, or a rack 415 of holders 471-476, as shown in FIG. 4C. The holders 410, 420, 430, 440, 450, 460 may be customized or personalized for the smart-charging clothing 500 to accommodate its features, such as shape, size, or weight.

In an embodiment of the present disclosure, the holders 410, 420, 430, 440, 450, 460 are fabricated or assembled from metallic materials, such as iron, copper, or foil. The holders 410, 420, 430, 440, 450, 460 may be electrically conductive and thermally conductive.

In another embodiment of the present disclosure, the holders 410, 420, 430, 440, 450, 460 are fabricated from non-metallic materials, such as wood, cloth, paper, plastic, or elastic. Such holders 410, 420, 430, 440, 450, 460 may be electrically insulative and thermally insulative.

The recharging interface 310 may recharge a smart-charging clothing 500 such as while it is not being worn by a user. The recharging interface 310 may be mobile or portable. The recharging interface 310 may be wireless. The recharging enclosure 100 may be non-contact.

The recharging interface 310 may include multiple recharging pads to recharge multiple smart-charging clothing 500. The recharging pads may accommodate multiple smart-charging clothing 500 that may be the same, similar, or different in attributes, such as type, purpose, appearance, functionality, size, shape, and weight. The recharging pads may be conductive, inductive, resonant, or a combination of the aforementioned.

The recharging interface 310, such as a rod, may include a first sensor 3100 to detect presence or absence of a holder 410 or smart-charging clothing 500 in a vicinity of the recharging enclosure. A Hall-effect type magnetic sensor may be used for detection. The recharging enclosure 310 may include a first actuator to move, orient, align, and secure the holder 410 with respect to a recharging pad on the recharging interface 310.

As shown in FIG. 3B, the holder 410, such as a hanger, may include an antenna 4100 to acquire a charging signal. The recharging interface 310 may further include a second sensor coupled to the antenna. The second sensor may scan, sense, detect, read, select, and provide a charging signal. The signal may include a near field signal. The second sensor may determine a voltage, a current, or a power level that is available.

The recharging interface 310 may include a switch to initiate, interrupt, resume, or terminate recharging of the smart-charging clothing 500. The switch may be accessed with Bluetooth, WiFi, Internet, or cellphone. The switch may also be connected to a timer. The recharging enclosure may include a transmitter to transmit the signal. The recharging enclosure may include a receiver to receive the signal. The recharging enclosure may include a modulator to modulate the signal. To modulate may involve altering and/or adjusting a characteristic or a quantity of the signal. The recharging enclosure may also include a conditioner to condition the signal.

Recharging may begin with or without human intervention. Recharging may end with or without human intervention. Recharging may operate through electromagnetic induction. In an embodiment, two coils are disposed in proximity and may be utilized in conjunction. An electromagnetic field transfers energy across a physical gap. Two objects may be inductively coupled across the gap. The energy may be used to recharge batteries or to operate the smart-charging clothing 500.

The recharging interface 310 may include shielding to prevent electrical noise or electromagnetic interference during recharging between smart recharging clothing 500s.

Methods and apparatuses have been described. It will be understood that the descriptions of some embodiments of the present disclosure do not limit the various alternative, modified and equivalent embodiments which may be included within the spirit and scope of the present disclosure as defined by the appended claims.

Furthermore, in the detailed description above, numerous specific details are set forth to provide an understanding of various embodiments of the present disclosure. However, some embodiments of the present disclosure may be practiced without these specific details. In other instances, well known methods, procedures, and components have not been described in detail so as not to unnecessarily obscure aspects of the present embodiments.

1. An apparatus for recharging a smart-charging clothing comprising:
a rod, the rod comprising a primary coil; and
a hanger connected to the rod, the hanger comprising a secondary coil, the secondary coil aligned and in proximity to the primary coil.

2. The apparatus of claim 1 further comprising a smart-charging clothing connected to the hanger.

3. The apparatus of claim 1 further comprising a power panel which is to provide an alternating current to the primary coil.

4. The apparatus of claim 1 further comprising a sensor coupled to an antenna wherein the sensor is to detect and acquire a charging signal.

5. A system, comprising:
an enclosure;
a module disposed within the enclosure;
a rod disposed within the module, the rod comprising a primary coil; and
a hanger connected to the rod, the hanger comprising a secondary coil for recharging a smart-charging clothing.

6. The system of claim 5, wherein the enclosure comprises at least one of a closet, a cupboard, or a box in a form of dwelling.

7. The system of claim 5, wherein the enclosure comprises at least one of a console or a compartment in a form of transportation.

8. The system of claim 5, wherein the enclosure comprises at least one of a console or a compartment in a form of storage.

9. The system of claim 5, wherein the hanger is incorporated within a garment bag, or a rack.

10. The system of claim 5, wherein the enclosure comprises a first actuator which is to align the smart-charging clothing with respect to a recharging pad disposed in the rod.

11. A method, comprising:
inserting a smart-charging clothing into a holder;
storing the holder in an enclosure;
connecting the smart-charging clothing to a recharging interface; and
recharging the smart-charging clothing using the recharging interface.

12. The method of claim 11 further comprising:
removing the holder from the enclosure; and removing the smart-charging clothing from the holder.

13. The method of claim 11, wherein the holder comprises at least one of a hanger, garment bag, or rack.

14. The method of claim 11, wherein the smart-charging clothing is connected to the recharging interface via a wireless connection.

15. The method of claim 11, wherein the smart-charging clothing is connected to the recharging interface via a physical connection.

16. The method of claim 11 further comprising:
inserting a plurality of smart-charging clothing into the holder;
connecting the smart-charging clothing to the recharging interface;
recharging the smart-charging clothing using the recharging interface.

17. The method of claim 16, wherein the plurality of smart-charging clothing are connected in parallel.

18. The method of claim 16, wherein the plurality of smart-charging clothing are connected in series.

19. The method of claim 16, wherein the plurality of smart-charging clothing are recharged in parallel.

20. The method of claim 16, wherein the plurality of smart-charging clothing are recharged in series.
